(19) United States
(12) Patent Application Publication
(10) Pub. No.: US 2008/0189769 A1
(43) Pub. Date: Aug. 7, 2008

(54) SECURE NETWORK SWITCHING INFRASTRUCTURE

(76) Inventors: Martin Casado, Menlo Park, CA (US); Nick Mckeown, Palo Alto, CA (US); Dan Boneh, Palo Alto, CA (US); Michael J. Freedman, Kingston, PA (US); Scott Shenker, Palo Alto, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/970,976

(22) Filed: Jan. 8, 2008

Related U.S. Application Data
(60) Provisional application No. 60/887,744, filed on Feb. 1, 2007.

(51) Int. Cl. G06F 21/22; H04L 9/32

(52) U.S. Cl. 726/4

(57) ABSTRACT

Use of a centralized control architecture in a network. Policy declaration, routing computation, and permission checks are managed by a logically centralized controller. By default, hosts on the network can only route to the network controller. Hosts and users must first authenticate themselves with the controller before they can request access to the network resources. The controller uses the first packet of each flow for connection setup. When a packet arrives at the controller, the controller decides whether the flow represented by that packet should be allowed. The switches use a simple flow table to forward packets under the direction of the controller. When a packet arrives that is not in the flow table, it is forwarded to the controller, along with information about which port the packet arrived on. When a packet arrives that is in the flow table, it is forwarded according to the controller's directive.

### CROSS REFERENCE TO RELATED APPLICATIONS

This application claims the benefit under 35 U.S.C. § 119(e) of U.S. Provisional Patent Application Ser. No. 60/887,744, entitled “Ethane: Taking Control of the Enterprise” by Martin Casado, Justin Pettit, Nick McKeown and Scott Shenker, filed Feb. 1, 2007, which is hereby incorporated by reference.

### BACKGROUND OF THE INVENTION

1. Field of the Invention

The invention relates to network packet switching, and more particularly, to secure network packet switching.

2. Description of the Related Art

The Internet architecture was born in a far more innocent era, when there was little need to consider how to defend against malicious attacks. Many of the Internet's primary design goals that were so critical to its success, such as universal connectivity and decentralized control, are now at odds with security.

Worms, malware, and sophisticated attackers mean that security can no longer be ignored. This is particularly true for enterprise networks, where it is unacceptable to lose data, expose private information, or lose system availability. Security measures have been retrofitted to enterprise networks via many mechanisms, including router ACLs, firewalls, NATs, and middleboxes, along with complex link-layer technologies such as VLANs.

Despite years of experience and experimentation, these mechanisms remain far from ideal and have created a management nightmare. Requiring a significant amount of configuration and oversight, they are often limited in the range of policies that they can enforce and produce networks that are complex and brittle. Moreover, even with these techniques, security within the enterprise remains notoriously poor. Worms routinely cause significant losses in productivity and increase potential for data loss. Attacks resulting in theft of intellectual property and other sensitive information are also common.

Various shortcomings are present in the architecture most commonly used in today's networks. Today's networking technologies are largely based on Ethernet and IP, both of which use a destination based datagram model for forwarding. The source addresses of the packets traversing the network are largely ignored by the forwarding elements. This has two important, negative consequences. First, a host can easily forge its source address to evade filtering mechanisms in the network. Source forging is particularly dangerous within a LAN environment where it can be used to poison switch learning tables and ARP caches. Source forging can also be used to fake DNS and DHCP responses. Secondly, lack of in-network knowledge of traffic sources makes it difficult to attribute a packet to a user or to a machine. At its most benign, lack of attribution can make it difficult to track down the location of “phantom-hosts.” More seriously, it may be impossible to determine the source of an intrusion given a sufficiently clever attacker.

A typical enterprise network today uses several mechanisms simultaneously to protect its network: VLANs, ACLs, firewalls, NATs, and so on. The security policy is distributed among the boxes that implement these mechanisms, making it difficult to correctly implement an enterprise-wide security policy. Configuration is complex; for example, routing protocols often require thousands of lines of policy configuration. Furthermore, the configuration is often dependent on network topology and based on addresses and physical ports, rather than on authenticated end-points. When the topology changes or hosts move, the configuration frequently breaks, requires careful repair, and potentially undermines its security policies.

A common response is to put all security policy in one box and at a choke-point in the network, for example, in a firewall at the network's entry and exit points. If an attacker makes it through the firewall, then they will have unfettered access to the whole network. Further, firewalls have been largely restricted to enforcing coarse-grain network perimeters. Even in this limited role, misconfiguration has been a persistent problem. This can be attributed to several factors; in particular, their low-level policy specification and highly localized view leaves firewalls highly sensitive to changes in topology.

Another way to address this complexity is to enforce protection of the end host via distributed firewalls. While reasonable, this places all trust in the end hosts. For this end hosts to perform enforcement, the end host must be trusted (or at least some part of it, e.g., the OS, a VMM, the NIC, or some small peripheral). End host firewalls can be disabled or bypassed, leaving the network unprotected, and they offer no containment of malicious infrastructure, e.g., a compromised NIDS. Furthermore, in a distributed firewall scenario, the network infrastructure itself receives no protection, i.e., the network still allows connectivity by default. This design affords no defense-in-depth if the end-point firewall is bypassed, as it leaves all other network elements exposed.

Today's networks provide a fertile environment for the skilled attacker. switches and routers must correctly export link state, calculate routes, and perform filtering; over time, these mechanisms have become more complex, with new vulnerabilities discovered at an alarming rate. If compromised, an attacker can take down the network or redirect traffic to permit eavesdropping, traffic analysis, and man-in-the-middle attacks.

Another resource for an attacker is the proliferation of information on the network layout of today's enterprises. This knowledge is valuable for identifying sensitive servers, firewalls, and IDS systems that can be exploited for compromise or denial of service. Topology information is easy to gather: switches and routers keep track of the network topology (e.g., the OSPF topology database) and broadcast it periodically in plain text. Likewise, host enumeration (e.g., ping and ARP scans), port scanning, traceroutes, and SNMP can easily reveal the existence of, and the route to, hosts. Today, it is common for network operators to filter ICMP and disable or change default SNMP passphrases to limit the amount of information available to an intruder. As these services become more difficult to access, however, the network becomes more difficult to diagnose.

Today's networks trust multiple components, such as firewalls, switches, routers, DNS, and authentication services (e.g., Kerberos, A D, and Radius). The compromise of any one component can wreak havoc on the entire enterprise.

Weaver et al. argue that existing configurations of coarse-grain network perimeters (e.g., NIDS and multiple firewalls) and end host protective mechanisms (e.g. antivirus software) are ineffective against worms when employed individually or in combination. They advocate augmenting traditional coarse-grain perimeters with fine-grain protection mechanisms throughout the network, especially to detect and halt worm propagation.

There are a number of Identity-Based Networking (IBN) solutions available in the industry. However, most lack control of the datapath, are passive, or require modifications to the end-hosts.

VLANs are widely used in enterprise networks for segmentation, isolation, and enforcement of course-grain policies; they are commonly used to quarantine unauthenticated hosts or hosts without health certificates. VLANs are notoriously difficult to use, requiring much hand-holding and manual configuration.

Often misconfigured routers make firewalls simply irrelevant by routing around them. The inability to answer simple reachability questions in today's enterprise networks has fueled commercial offerings to help administrators discover what connectivity exists in their network.

In their 4D architecture, Rexford et al., “NetworkWide Decision Making: Toward A Wafer-Thin Control Plane,” Proc. Hotnets, November 2004, argue that the decentralized routing policy, access control, and management has resulted in complex routers and cumbersome, difficult-to-manage networks. They argue that routing (the control plane) should be separated from forwarding, resulting in a very simple data path. Although 4D centralizes routing policy decisions, they retain the security model of today's networks. Routing (forwarding tables) and access controls (filtering rules) are still decoupled, disseminated to forwarding elements, and operate the basis of weakly-bound end-point identifiers (IP addresses).

Predicate routing attempts to unify security and routing by defining connectivity as a set of declarative statements from which routing tables and filters are generated. In contrast, our goal is to make users first-class objects, as opposed to end-point IDs or IP addresses, that can be used to define access controls.

In addition to retaining the characteristics that have resulted in the wide deployment of IP and Ethernet networks—simple use model, suitable (e.g., Gigabit) performance, the ability to scale to support large organizations, and robustness and adaptability to failure—a solution should address the deficiencies addressed here.

### SUMMARY OF THE INVENTION

In order to achieve the properties described in the previous section, embodiments according to our invention utilize a centralized control architecture. The preferred architecture is managed from a logically centralized controller. Rather than distributing policy declaration, routing computation, and permission checks among the switches and routers, these functions are all managed by the controller. As a result, the switches are reduced to very simple, forwarding elements whose sole purpose is to enforce the controller's decisions.

Centralizing the control functions provides the following benefits. First, it reduces the trusted computing base by minimizing the number of heavily trusted components on the network to one, in contrast to the prior designs in which a compromise of any of the trusted services, LDAP, DNS, DHCP, or routers can wreak havoc on a network. Secondly, limiting the consistency protocols between highly trusted entities protects them from attack. Prior consistency protocols are often done in plaintext (e.g. dyndns) and can thus be subverted by a malicious party with access to the traffic. Finally, centralization reduces the overhead required to maintain consistency.

In the preferred embodiments the network is “off-by-default.” That is, by default, hosts on the network cannot communicate with each other; they can only route to the network controller. Hosts and users must first authenticate themselves with the controller before they can request access to the network resources and, ultimately, to other end hosts. Allowing the controller to interpose on each communication allows strict control over all network flows. In addition, requiring authentication of all network principals (hosts and users) allows control to be defined over high level names in a secure manner.

The controller uses the first packet of each flow for connection setup. When a packet arrives at the controller, the controller decides whether the flow represented by that packet should be allowed. The controller knows the global network topology and performs route computation for permitted flows. It grants access by explicitly enabling flows within the network switches along the chosen route. The controller can be replicated for redundancy and performance.

In the preferred embodiments the switches are simple and dumb. The switches preferably consist of a simple flow table which forwards packets under the direction of the controller. When a packet arrives that is not in the flow table, they forward that packet to the controller, along with information about which port the packet arrived on. When a packet arrives that is in the flow table, it is forwarded according to the controller's directive. Not every switch in the network needs to be one of these switches as the design allows switches to be added gradually; the network becomes more manageable with each additional switch.

When the controller checks a packet against the global policy, it is preferably evaluating the packet against a set of simple rules, such as “Guests can communicate using HTTP, but only via a web proxy” or “VoIP phones are not allowed to communicate with laptops.” To aid in allowing this global policy to be specified in terms of such physical entities, there is a need to reliably and securely associate a packet with the user, group, or machine that sent it. If the mappings between machine names and IP addresses (DNS) or between IP addresses and MAC addresses (ARP and DHCP) are handled elsewhere and are unreliable, then it is not possible to tell who sent the packet, even if the user authenticates with the network. With logical centralization it is simple to keep the namespace consistent, as components join, leave and move around the network. Network state changes simply require updating the bindings at the controller.

In the preferred embodiments a series of sequences of techniques are used to secure the bindings between packet headers and the physical entities that sent them. First, the controller takes over all the binding of addresses. When machines use DHCP to request an IP address, the controller assigns it knowing to which switch port the machine is connected, enabling the controller to attribute an arriving packet to a physical port. Second, the packet must come from a machine that is registered on the network, thus attributing it to a particular machine. Finally, users are required to authenticate themselves with the network, for example, via HTTP redirects in a manner similar to those used by commercial WiFi hotspots, binding users to hosts. Therefore, whenever a packet arrives to the controller, it can securely associate the packet to the particular user and host that sent it.

There are several powerful consequences of the controller knowing both where users and machines are attached and all bindings associated with them. The controller can keep track of where any entity is located. When it moves, the controller finds out as soon as packets start to arrive from a different switch port or wireless access point. The controller can choose to allow the new flow (it can even handle address mobility directly in the controller without modifying the host) or it might choose to deny the moved flow (e.g., to restrict mobility for a VoIP phone due to E911 regulations). Another powerful consequence is that the controller can journal all bindings and flow-entries in a log. Later, if needed, the controller can reconstruct all network events; e.g., which machines tried to communicate or which user communicated with a service. This can make it possible to diagnose a network fault or to perform auditing or forensics, long after the bindings have changed.

Therefore networks according to the present invention address problems with prior art network architectures, improving overall network security.

### BRIEF DESCRIPTION OF THE FIGURES

FIG. 1 is a block diagram of a network according to the present invention.

FIG. 2 is a block diagram of the logical components of the controller of FIG. 1.

FIG. 3 is a block diagram of switch hardware and software according to the present invention.

FIG. 4 is a block diagram of the data path of the switch of FIG. 3.

FIG. 5 is a block diagram of software modules of the switch of FIG. 3.

FIGS. 6 and 7 are block diagrams of networks incorporating prior art switches and switches according to the present invention.

### DETAILED DESCRIPTION OF THE PREFERRED EMBODIMENT

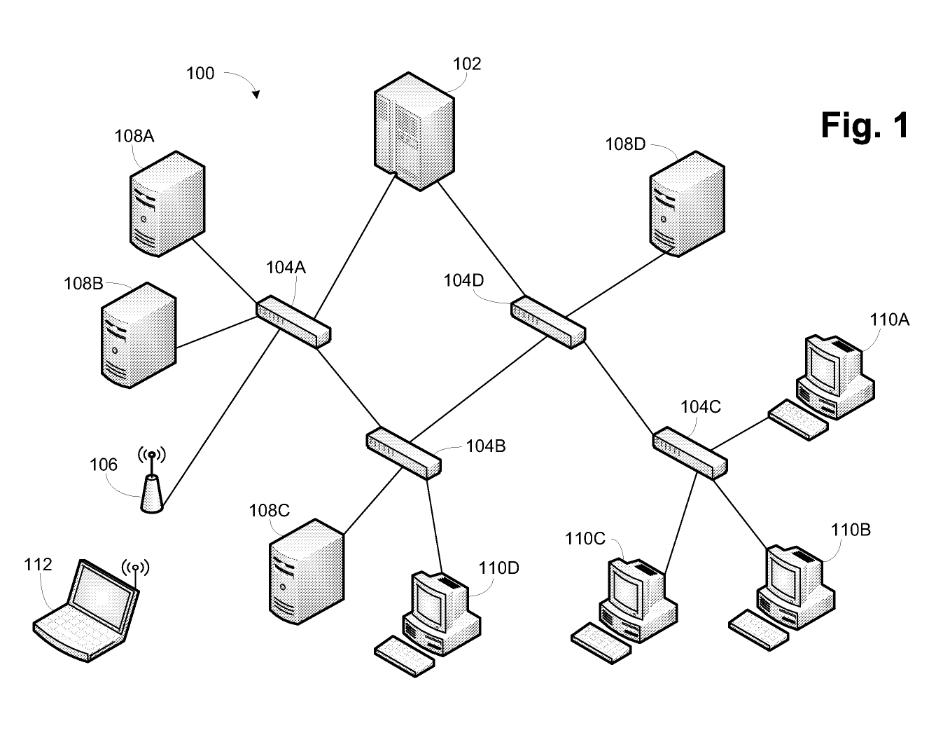

Referring now to FIG. 1, a network 100 according to the present invention is illustrated. A controller 102 is present to provide network control functions as described below. A series of interconnected switches 104A-D are present to provide the basic packet switching function. A wireless access point 106 is shown connected to switch 104A to provide wireless connectivity. For the following discussion, in many aspects the access point 106 operates as a switch 104. Servers 108A-D and workstations 110A-D are connected to the switches 104A-D. A notebook computer 112 having wireless network capabilities connects to the access point 106. The servers 108, workstations 110 and notebook 112 are conventional units and are not modified to operate on the network 100. This is a simple network for purposes of illustration. An enterprise network will have vastly more components but will function on the same principles.

With reference to FIG. 1, there are five basic activities that define how the network 100 operates. A first activity is registration. All switches 104, users, servers 108, workstations 110 and notebooks 112 are registered at the controller 102 with the credentials necessary to authenticate them. The credentials depend on the authentication mechanisms in use. For example, hosts, collectively the servers 108, workstations 110 and notebooks 112, may be authenticated by their MAC addresses, users via username and password, and switches through secure certificates. All switches 104 are also preconfigured with the credentials needed to authenticate the controller 102 (e.g., the controller's public key).

A second activity is bootstrapping. Switches 104 bootstrap connectivity by creating a spanning tree rooted at the controller 102. As the spanning tree is being created, each switch 104 authenticates with and creates a secure channel to the controller 102. Once a secure connection is established, the switches 104 send link-state information to the controller 102 which is then aggregated to reconstruct the network topology. Each switch 104 knows only a portion of the network topology. Only the controller 102 is aware of the full topology, thus improving security.

A third activity is authentication. Assume User A joins the network with host 110C. Because no flow entries exist in switch 104D for the new host, it will initially forward all of the host 110C packets to the controller 102 (marked with the switch 104D ingress port, the default operation for any unknown packet). Next assume Host 100C sends a DHCP request to the controller 102. After checking the host 110C MAC address, the controller 102 allocates an IP address (IP 110C) for it, binding host 110C to IP 110C, IP 110C to MAC 110C, and MAC 110C to a physical port on switch 104D. In the next operation User A opens a web browser, whose traffic is directed to the controller 102, and authenticates through a web-form. Once authenticated, user A is bound to host 102.

A fourth activity is flow setup. To begin, User A initiates a connection to User B at host 110D, who is assumed to have already authenticated in a manner similar to User A. Switch 104D forwards the packet to the controller 102 after determining that the packet does not match any active entries in its flow table. On receipt of the packet, the controller 102 decides whether to allow or deny the flow, or require it to traverse a set of waypoints. If the flow is allowed, the controller 102 computes the flow's route, including any policy-specified waypoints on the path. The controller 102 adds a new entry to the flow tables of all the switches 104 along the path.

The fifth aspect is forwarding. If the controller 102 allowed the path, it sends the packet back to switch 104D which forwards it to the switch 104C based on the new flow entry. Switch 104C in turn forwards the packet to switch 104B, which in turn forwards the packet to host 110D based on its new flow entry. Subsequent packets from the flow are forwarded directly by the switch 104D, and are not sent to the controller 102. The flow-entry is kept in the relevant switches 104 until it times out or is revoked by the controller 102.

A switch 104 is like a simplified Ethernet switch. It has several Ethernet interfaces that send and receive standard Ethernet packets. Internally, however, the switch 104 is much simpler, as there are several things that conventional Ethernet switches do that the switch 104 need not do. The switch 104 does not need to learn addresses, support VLANs, check for source-address spoofing, or keep flow-level statistics (e.g., start and end time of flows, although it will typically maintain per flow packet and byte counters for each flow entry). If the switch 104 is replacing a layer-3 “switch” or router, it does not need to maintain forwarding tables, ACLs, or NAT. It does not need to run routing protocols such as OSPF, ISIS, and RIP. Nor does it need separate support for SPANs and port-replication. Port-replication is handled directly by the flow table under the direction of the controller 102.

It is also worth noting that the flow table can be several orders-of-magnitude smaller than the forwarding table in an equivalent Ethernet switch. In an Ethernet switch, the table is sized to minimize broadcast traffic: as switches flood during learning, this can swamp links and makes the network less secure. As a result, an Ethernet switch needs to remember all the addresses it's likely to encounter; even small wiring closet switches typically contain a million entries. The present switches 104, on the other hand, can have much smaller flow tables: they only need to keep track of flows in-progress. For a wiring closet, this is likely to be a few hundred entries at a time, small enough to be held in a tiny fraction of a switching chip. Even for a campus-level switch, where perhaps tens of thousands of flows could be ongoing, it can still use on-chip memory that saves cost and power.

The switch 104 datapath is a managed flow table. Flow entries contain a Header (to match packets against), an Action (to tell the switch 104 what to do with the packet), and Per-Flow Data described below. There are two common types of entries in the flow table: per-flow entries describing application flows that should be forwarded, and per-host entries that describe misbehaving hosts whose packets should be dropped. For TCP/UDP flows, the Header field covers the TCP/UDP, IP, and Ethernet headers, as well as physical port information. The associated Action is to forward the packet to a particular interface, update a packet-and-byte counter in the Per-Flow Data, and set an activity bit so that inactive entries can be timed-out. For misbehaving hosts, the Header field contains an Ethernet source address and the physical ingress port. The associated Action is to drop the packet, update a packet-and-byte counter, and set an activity bit to tell when the host has stopped sending.

Only the controller 102 can add entries to the flow table of the switch 104. Entries are removed because they timeout due to inactivity, which is a local decision, or because they are revoked by the controller 102. The controller 102 might revoke a single, badly behaved flow, or it might remove a whole group of flows belonging to a misbehaving host, a host that has just left the network, or a host whose privileges have just changed.

The flow table is preferably implemented using two exact-match tables: One for application flow entries and one for misbehaving host entries. Because flow entries are exact matches, rather than longest-prefix matches, it is easy to use hashing schemes in conventional memories rather than expensive, power-hungry TCAMs.

Other actions are possible in addition to just forward and drop. For example, a switch 104 might maintain multiple queues for different classes of traffic, and the controller 102 can tell it to queue packets from application flows in a particular queue by inserting queue IDs into the flow table. This can be used for end-to-end layer-2 isolation for classes of users or hosts. A switch 104 could also perform address translation by replacing packet headers. This could be used to obfuscate addresses in the network 100 by “swapping” addresses at each switch 104 along the path, so that an eavesdropper would not be able to tell which end-hosts are communicating, or to implement address translation for NAT in order to conserve addresses. Finally, a switch 104 could control the rate of a flow.

The switch 104 also preferably maintains a handful of implementation-specific entries to reduce the amount of traffic sent to the controller 102. For example, the switch 104 can set up symmetric entries for flows that are allowed to be outgoing only. This number should remain small to keep the switch 104 simple, although this is at the discretion of the designer. On one hand, such entries can reduce the amount of traffic sent to the controller 102; on the other hand, any traffic that misses on the flow table will be sent to the controller 102 anyway, so this is just an optimization.

It is worth pointing out that the secure channel from a switch 104 to its controller 102 may pass through other switches 104. As far as the other switches 104 are concerned, the channel simply appears as an additional flow-entry in their table.

The switch 104 needs a small local manager to establish and maintain the secure channel to the controller 102, to monitor link status, and to provide an interface for any additional switch-specific management and diagnostics. This can be implemented in the switch's software layer.

There are two ways a switch 104 can talk to the controller 102. The first one, which has been discussed so far, is for switches 104 that are part of the same physical network as the controller 102. This is expected to be the most common case; e.g., in an enterprise network on a single campus. In this case, the switch 104 finds the controller 102, preferably using the modified Minimum Spanning Tree protocol described below. The process results in a secure channel from switch 104 to switch 104 all the way to the controller 102. If the switch 104 is not within the same broadcast domain as the controller 102, the switch 104 can create an IP tunnel to it after being manually configured with its IP address. This approach can be used to control switches 104 in arbitrary locations, e.g., the other side of a conventional router or in a remote location. In one interesting application, the switch 104, most likely a wireless access point 106, is placed in a home or small business, managed remotely by the controller 102 over this secure tunnel. The local switch manager relays link status to the controller 102 so it can reconstruct the topology for route computation.

Switches 104 maintain a list of neighboring switches 104 by broadcasting and receiving neighbor-discovery messages. Neighbor lists are sent to the controller 102 after authentication, on any detectable change in link status, and periodically every 15 seconds.

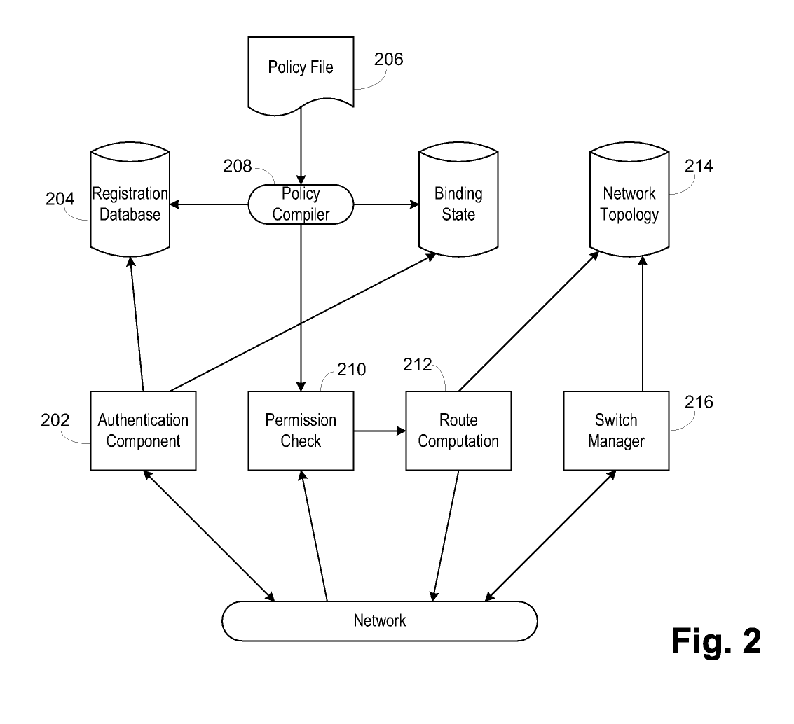

FIG. 2 gives a logical block-diagram of the controller 102. The components do not have to be co-located on the same machine and can operate on any suitable hardware and software environment, the hardware including a CPU, memory for storing data and software programs, and a network interface and the software including an operating system, a network interface driver and various other components described below.

Briefly, the components work as follows. An authentication component 202 is passed all traffic from unauthenticated or unbound MAC addresses. It authenticates users and hosts using credentials stored in a registration database 204 and optionally provides IP addresses when serving as the DHCP server. Once a host or user authenticates, the controller 102 remembers to which switch port they are connected. The controller 102 holds the policy rules, stored in a policy file 206, which are compiled by a policy compiler 208 into a fast lookup table (not shown). When a new flow starts, it is checked against the rules by a permission check module 210 to see if it should be accepted, denied, or routed through a waypoint. Next, a route computation module 212 uses the network topology 214 to pick the flow's route which is used in conjunction with the permission information from the permission check module 210 to build the various flow table entries provided to the switches 104. The topology 214 is maintained by a switch manager 216, which receives link updates from the switches 104 as described above.

All entities that are to be named by the network 100 (i.e., hosts, protocols, switches, users, and access points) must be registered. The set of registered entities make up the policy namespace and is used to statically check the policy to ensure it is declared over valid principles. The entities can be registered directly with the controller 102, or—as is more likely in practice, the controller 102 can interface with a global registry such as LDAP or AD, which would then be queried by the controller 102. By forgoing switch registration, it is also possible to provide the same “plug-and-play 102” configuration model for switches as Ethernet. Under this configuration the switches 104 would distribute keys on boot-up, rather than requiring manual distribution, under the assumption that the network 100 has not yet been compromised.

All switches, hosts, and users must authenticate with the network 100. No particular host authentication mechanism is specified; a network 100 could support multiple authentication methods (e.g., 802.1x or explicit user login) and employ entity-specific authentication methods. In a preferred embodiment hosts authenticate by presenting registered MAC addresses, while users authenticate through a web front-end to a Kerberos server. Switches 104 authenticate using SSL with server- and client-side certificates.

One of the powerful features of the present network 100 is that it can easily track all the bindings between names, addresses, and physical ports on the network 100, even as switches 104, hosts, and users join, leave, and move around the network 100. It is this ability to track these dynamic bindings that makes a policy language possible. It allows description of policies in terms of users and hosts, yet implementation of the policy uses flow tables in switches 104.

A binding is never made without requiring authentication, to prevent an attacker assuming the identity of another host or user. When the controller 102 detects that a user or host leaves, all of its bindings are invalidated, and all of its flows are revoked at the switch 104 to which it was connected. Unfortunately, in some cases, we cannot get reliable explicit join and leave events from the network 100. Therefore, the controller 102 may resort to timeouts or the detection of movement to another physical access point before revoking access.

Because the controller 102 tracks all the bindings between users, hosts, and addresses, it can make information available to network managers, auditors, or anyone else who seeks to understand who sent what packet and when. In current networks, while it is possible to collect packet traces, it is almost impossible to figure out later which user, or even which host, sent or received the packets, as the addresses are dynamic and there is no known relationship between users and packet addresses.

The controller 102 can journal all the authentication and binding information: The machine a user is logged in to, the switch port their machine is connected to, the MAC address of their packets, and so on. Armed with a packet trace and such a journal, it is possible to determine exactly which user sent a packet, when it was sent, the path it took, and its destination. Obviously, this information is very valuable for both fault diagnosis and identifying break-ins. On the other hand, the information is sensitive and controls need to be placed on who can access it. Therefore the controllers 102 should provide an interface that gives privileged users access to the information. In one preferred embodiment, we built a modified DNS server that accepts a query with a timestamp, and returns the complete bound namespace associated with a specified user, host, or IP address.

The controller 102 can be implemented to be stateful or stateless. A stateful controller 102 keeps track of all the flows it has created. When the policy changes, when the topology changes, or when a host or user misbehaves, a stateful controller 102 can traverse its list of flows and make changes where necessary. A stateless controller 102 does not keep track of the flows it created; it relies on the switches 104 to keep track of their flow tables. If anything changes or moves, the associated flows would be revoked by the controller 102 sending commands to the switch's Local Manager. It as a design choice whether a controller 102 is stateful or stateless, as there are arguments for and against both approaches.

There are many occasions when a controller 102 wants to limit the resources granted to a user, host, or flow. For example, it might wish to limit a flow's rate, limit the rate at which new flows are setup, or limit the number of IP addresses allocated. The limits will depend on the design of the controller 102 and the switch 104, and they will be at the discretion of the network manager. In general, however, the present invention makes it easy to enforce these limits either by installing a filter in a switch's flow table or by telling the switch 104 to limit a flow's rate.

The ability to directly manage resources from the controller 102 is the primary means of protecting the network from resource exhaustion attacks. To protect itself from connection flooding from unauthenticated hosts, a controller 102 can place a limit on the number of authentication requests per host and per switch port; hosts that exceed their allocation can be closed down by adding an entry in the flow table that blocks their Ethernet address. If such hosts spoof their address, the controller 102 can disable the switch port. A similar approach can be used to prevent flooding from authenticated hosts.

Flow state exhaustion attacks are also preventable through resource limits. Since each flow setup request is attributable to a user, host or access point, the controller 102 can enforce limits on the number of outstanding flows per identifiable source. The network 100 may also support more advanced flow allocation policies, such as enforcing strict limits on the number of flows forwarded in hardware per source, and looser limits on the number of flows in the slower (and more abundant) software forwarding tables.

Enterprise networks typically carry a lot of multicast and broadcast traffic. Indeed, VLANs were first introduced to limit overwhelming amounts of broadcast traffic. It is worth distinguishing broadcast traffic which is mostly discovery protocols, such as ARP from multicast traffic which is often from useful applications, such as video. In a flow-based network as in the present invention, it is quite easy for switches 104 to handle multicast. The switch 104 keeps a bitmap for each flow to indicate which ports the packets are to be sent to along the path.

In principle, broadcast discovery protocols are also easy to handle in the controller 102. Typically, a host is trying to find a server or an address. Given that the controller 102 knows all, it can reply to a request without creating a new flow and broadcasting the traffic. This provides an easy solution for ARP traffic, which is a significant fraction of all network traffic. The controller 102 knows all IP and Ethernet addresses and can reply directly. In practice, however, ARP could generate a huge load for the controller 102. One embodiment would be to provide a dedicated ARP server in the network 100 to which that all switches 104 direct all ARP traffic. But there is a dilemma when trying to support other discovery protocols; each one has its own protocol, and it would be onerous for the controller 102 to understand all of them. The preferred approach has been to implement the common ones directly in the controller 102, and then broadcast low-level requests with a rate-limit. While this approach does not scale well, this is considered a legacy problem and discovery protocols will largely go away when networks according to the present invention are adopted, being replaced by a direct way to query the network, suc as one similar to the fabric login used in Fibre Channel networks.

Designing a network architecture around a central controller 102 raises concerns about availability and scalability. While measurements discussed below suggest that thousands of machines can be managed by a single desktop computer, multiple controllers 102 may be desirable to provide fault-tolerance or to scale to very large networks. This section describes three techniques for replicating the controller 102. In the simplest two approaches, which focus solely on improving fault-tolerance, secondary controllers 102 are ready to step in upon the primary's failure. These can be in cold-standby, having no network binding state, or warm-standby, having network binding state, modes. In the fully-replicated model, which also improves scalability, requests from switches 104 are spread over multiple active controllers 102.

In the cold-standby approach, a primary controller 102 is the root of the modified spanning tree (MST) and handles all registration, authentication, and flow establishment requests. Backup controllers sit idly-by waiting to take over if needed. All controllers 102 participate in the MST, sending HELLO messages to switches 104 advertising their ID. Just as with a standard spanning tree, if the root with the “lowest” ID fails, the network 100 will converge on a new root, i.e., a new controller. If a backup becomes the new MST root, they will start to receive flow requests and begin acting as the primary controller. In this way, controllers 102 can be largely unaware of each other. The backups need only contain the registration state and the network policy. As this data changes very slowly, simple consistency methods can be used. The main advantage of cold-standby is its simplicity. The downside is that hosts, switches, and users need to re-authenticate and re-bind upon primary failure. Furthermore, in large networks, it might take a while for the MST to reconverge.

The warm-standby approach is more complex, but recovers faster. In this approach, a separate MST is created for every controller. The controllers monitor one another's liveness and, upon detecting the primary's failure, a secondary controller takes over based on a static ordering. As before, slowly-changing registration and network policy are kept consistent among the controllers, but now binds must be replicated across controllers as well. Because these bindings can change quickly as new users and hosts come and go, it is preferred that only weak consistency be maintained. Because controllers make bind events atomic, primary failures can at worst lose the latest bindings, requiring that some new users and hosts re-authenticate themselves.

The fully-replicated approach takes this one step further and has two or more active controllers. While an MST is again constructed for each controller, a switch need only authenticate itself to one controller and can then spread its flow-requests over the controllers (e.g., by hashing or round-robin). With such replication, the job of maintaining consistent journals of the bind events is more difficult. It is preferred that most implementations will simply use gossiping to provide a weakly-consistent ordering over events. Pragmatic techniques can avoid many potential problems that would otherwise arise, e.g., having controllers use different private IP address spaces during DHCP allocation to prevent temporary IP allocation conflicts. Of course, there are well-known, albeit heavier-weight, alternatives to provide stronger consistency guarantees if desired (e.g., replicated state machines).

Link and switch failures must not bring down the network 100 as well. Recall that switches 104 always send neighbor-discovery messages to keep track of link-state. When a link fails, the switch 104 removes all flow table entries tied to the failed port and sends its new link-state information to the controller 102. This way, the controller 102 also learns the new topology. When packets arrive for a removed flow-entry at the switch 104, the packets are sent to the controller 102, much like they are new flows, and the controller 102 computes and installs a new path based on the new topology.

When the network 100 starts, the switches 104 must connect and authenticate with the controller 102. On startup, the network creates a minimum spanning tree with the controller 102 advertising itself as the root. Each switch 104 has been configured with credentials for the controller 102 and the controller 102 with the credentials for all the switches 104. If a switch 104 finds a shorter path to the controller 102, it attempts two way authentication with it before advertising that path as a valid route. Therefore the minimum spanning tree grows radially from the controller 102, hop-by-hop as each switch 104 authenticates.

Authentication is done using the preconfigured credentials to ensure that a misbehaving node cannot masquerade as the controller 102 or another switch 104. If authentication is successful, the switch 104 creates an encrypted connection with the controller 102 which is used for all communication between the pair.

By design, the controller 102 knows the upstream switch 104 and physical port to which each authenticating switch 104 is attached. After a switch 104 authenticates and establishes a secure channel to the controller 102, it forwards all packets it receives for which it does not have a flow entry to the controller 102, annotated with the ingress port. This includes the traffic of authenticating switches 104. Therefore the controller 102 can pinpoint the attachment point to the spanning tree of all non-authenticated switches 104 and hosts. Once a switch 104 authenticates, the controller 102 will establish a flow in the network between itself and a switch 104 for the secure channel.

Pol-Eth is a language according to the present invention for declaring policy in the network 100. While a particular language is not required, Pol-Eth is described as an example.

In Pol-Eth, network policy is declared as a set of rules, each consisting of a condition and a corresponding action. For example, the rule to specify that user bob is allowed to communicate with the HTTP server (using HTTP) is:

[(usrc=“bob”)̂(protocol=“http”)̂(hdst=“web-server”)]:allow;

Conditions are a conjunction of zero or more predicates which specify the properties a flow must have in order for the action to be applied. From the preceding example rule, if the user initiating the flow is “bob” and the flow protocol is “HTTP” and the flow destination is host “http-server”, then the flow is allowed. The left hand side of a predicate specifies the domain, and the right hand side gives the entities to which it applies. For example, the predicate (usrc=“bob”) applies to all flows in which the source is user bob. Valid domains include {usrc, udst, hsrc, hdst, apsrc, apdst, protocol}, which respectively signify the user, host, and access point sources and destinations and the protocol of the flow.

In Pol-Eth, the values of predicates may include single names (e.g., “bob”), lists of names (e.g., [“bob”, “linda”]), or group inclusion (e.g., in (“workstations”)). All names must be registered with the controller 102 or declared as groups in the policy file, as described below.

Actions include allow, deny, waypoints, and outbound-only (for NAT-like security). Waypoint declarations include a list of entities to route the flow through, e.g., waypoints (“ids”, “http-proxy”).

Pol-Eth rules are independent and do not contain an intrinsic ordering. Thus, multiple rules with conflicting actions may be satisfied by the same flow. Conflicts are preferably resolved by assigning priorities based on declaration order, though other resolution techniques may be used. If one rule precedes another in the policy file, it is assigned a higher priority.

As an example, in the following declaration, bob may accept incoming connections even if he is a student.

# bob is unrestricted [(udst=“bob”)]:allow;

# all students can make outbound connections [(usrc=in(“students”))]:outbound-only;

# deny everything by default) [ ]: deny;

Unfortunately, in today's multi-user operating systems, it is difficult from a network perspective to attribute outgoing traffic to a particular user. According to the present invention, if multiple-users are logged into the same machine (and not identifiable from within the network), the network applies the least restrictive action to each of the flows. This is an obvious relaxation of the security policy. To address this, it is possible to integrate with trusted end-host operating systems to provide user-isolation and identification, for example, by providing each user with a virtual machine having a unique MAC.

Pol-Eth also allows predicates to contain arbitrary functions. For example, the predicate (expr=“foo”) will execute the function “foo” at runtime and use the boolean return value as the outcome. Predicate functions are written in C++ and executed within the network namespace. During execution, they have access to all parameters of the flow as well as to the full binding state of the network.

The inclusion of arbitrary functions with the expressibility of a general programming language allows predicates to maintain local state, affect system state, or access system libraries. For example, we have created predicates that depend on the time-of-day and contain dependencies on which users or hosts are logged onto the network. A notable downside is that it becomes impossible to statically reason about safety and execution times: a poorly written function can crash the controller or slow down permission checks.

Given how frequently new flows are created—and how fast decisions must be made—it is not practical to interpret the network policy. Instead, it is preferred to compile it. But compiling Pol-Eth is non-trivial because of the potentially huge namespace in the network. Creating a lookup table for all possible flows specified in the policy would be impractical.

A preferred Pol-Eth implementation combines compilation and just-in-time creation of search functions. Each rule is associated with the principles to which it applies. This is a one-time cost, performed at startup and on each policy change.

The first time a sender communicates to a new receiver, a custom permission check function is created dynamically to handle all subsequent flows between the same source/destination pair. The function is generated from the set of rules which apply to the connection. In the worst case, the cost of generating the function scales linearly with the number of rules (assuming each rule applies to every source entity). If all of the rules contain conditions that can be checked statically at bind time (i.e., the predicates are defined only over users, hosts, and access points), then the resulting function consists solely of an action. Otherwise, each flow request requires that the actions be aggregated in real-time.

We have implemented a source-to-source compiler that generates C++ from a Pol-Eth policy file. The resulting source is then compiled and linked into a binary. As a consequence, policy changes currently require re-linking the controller. We are currently upgrading the policy compiler so that policy changes can be dynamically loaded at runtime.

A functional embodiment of a network according to the present invention has been built and deployed. In that embodiment the network 100 connected over 300 registered hosts and several hundred users. The embodiment included 19 switches of three different types: wireless access points 106, and Ethernet switches in two types dedicated hardware and software. Registered hosts included laptops, printers, VoIP phones, desktop workstations and servers.

Three different switches have been tested. The first is an 802.11g wireless access point based on a commercial access point. The second is a wired 4-port Gigabit Ethernet switch that forwards packets at line-speed based on the NetFPGA programmable switch platform, and written in Verilog. The third is a wired 4-port Ethernet switch in Linux on a desktop-PC in software, as a development environment and to allow rapid deployment and evolution.

For design re-use, the same flow table was implemented in each switch design even though it is preferable to optimize for each platform. The main table for packets that should be forwarded has 8 k flow entries and is searched using an exact match on the whole header. Two hash functions (two CRCs) were used to reduce the chance of collisions, and only one flow was placed in each entry of the table. 8 k entries were chosen because of the limitations of the programmable hardware (NetFPGA). A commercial ASIC-based hardware switch, an NPU-based switch, or a software-only switch would support many more entries. A second table was implemented to hold dropped packets which also used exact-match hashing. In that implementation, the dropped table was much bigger (32 k entries) because the controller was stateless and the outbound-only actions were implemented in the flow table. When an outbound flow starts, it is preferable to setup the return-route at the same time. Because the controller is stateless, it does not remember that the outbound-flow was allowed. Unfortunately, when proxy ARP is used, the Ethernet address of packets flowing in the reverse direction were not known until they arrive. The second table was used to hold flow entries for return-routes, with a wildcard Ethernet address, as well as for dropped packets. A stateful controller would not need these entries. Finally, a third small table for flows with wildcards in any field was used. These are there for convenience during prototyping, to aid in determining how many entries a real deployment would need. It holds flow entries for the spanning tree messages, ARP and DHCP.

The access point ran on a Linksys WRTSL54GS wireless router running OpenWRT. The data-path and flow table were based on 5K lines of C++, of which 1.5K were for the flow table. The local switch manager is written in software and talks to the controller using the native Linux TCP stack. When running from within the kernel, the forwarding path runs at 23 Mb/s, the same speed as Linux IP forwarding and layer 2 bridging.

The hardware switch was implemented on NetFPGA v2.0 with four Gigabit Ethernet ports, a Xilinx Virtex-IT FPGA and 4 Mbytes of SRAM for packet buffers and the flow table. The hardware forwarding path consisted of 7 k lines of Verilog; flow-entries were 40 bytes long. The hardware can forward minimum size packets in full-duplex at line-rate of 1 Gb/s.

To simplify definition of a switch, a software switch was built from a regular desktop-PC and a 4-port Gigabit Ethernet card. The forwarding path and the flow table was implemented to mirror the hardware implementation. The software switches in kernel mode can forward MTU size packets at 1 Gb/s. However, as the packet size drops, the CPU cannot keep up. At 100 bytes, the switch can only achieve a throughput of 16 Mb/s. Clearly, for now, the switch needs to be implemented in hardware.

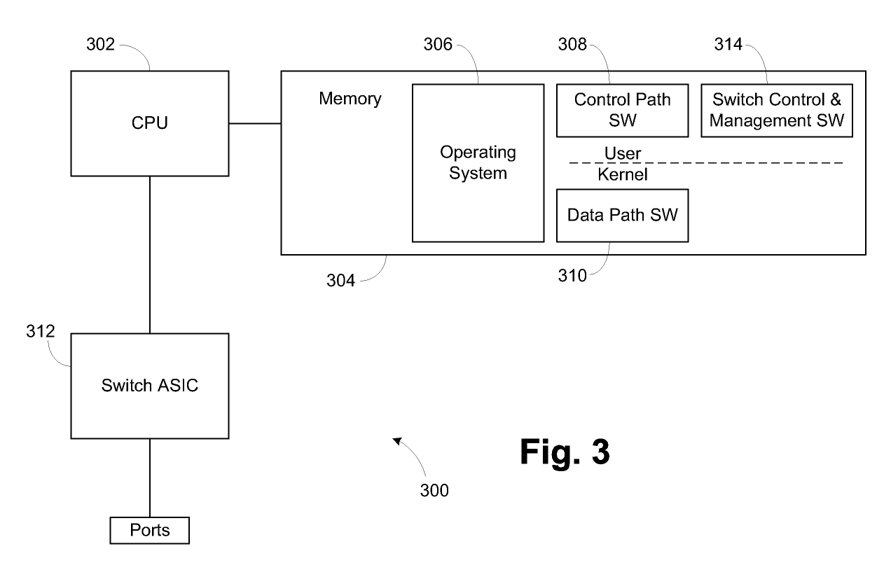

The preferred switch design as shown in FIG. 3 is decomposed into two memory independent processes, the datapath and the control path. A CPU or processor 302 forms the primary compute and control functions of the switch 300. Switch memory 304 holds the operating system 306, such as Linux; control path software 308 and datapath software 310. A switch ASIC 312 is used in the preferred embodiment to provide hardware acceleration to readily enable line rate operation. If the primary datapath operators are performed by the datapath software 310, the ASIC 312 is replaced by a simple network interface. The control path software 308 manages the spanning tree algorithm, and handles all communication with the controller and performs other local manager functions. The datapath software 310 performs the forwarding.

The control path software 308 preferably runs exclusively in user-space and communicates to the datapath software 310 over a special interface exported by the datapath software 310. The datapath software 310 may run in user-space or within the kernel. When running with the hardware switch ASIC 312, the datapath software 310 handles setting the hardware flow entries, secondary and tertiary flow lookups, statistics tracking, and timing out flow entries. switch control and management software 314 is also present to perform those functions described in more detail below.

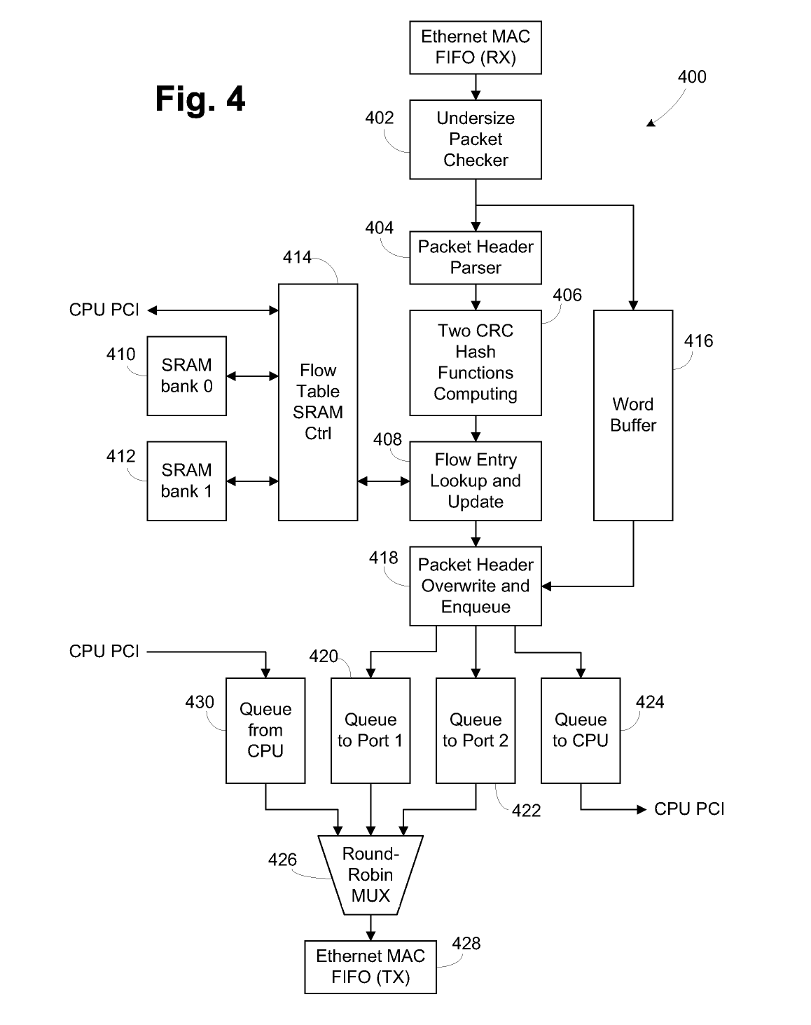

FIG. 4 shows a decomposition of the functional software and hardware layers making up the switch datapath. In Block 402 received packets are checked for a valid length and undersized packets are dropped. In preparation for calculating the hash-functions, Block 404 parses the packet header to extract the following fields: Ethernet header, IP header, and TCP or UDP header.

A flow-tuple is built for each received packet; for an IPv4 packet, the tuple has 155 bits consisting of: MAC DA (lower 16 bits), MAC SA (lower 16 bits), Ethertype (16 bits), IP src address (32 bits), IP dst address (32 bits), IP protocol field (8 bits), TCP or UDP src port number (16 bits), TCP or UDP dst port number (16 bits), received physical port number (3 bits).

Block 406 computes two hash functions on the flow-tuple (padded to 160 bits), and returns two indices. Block 408 uses the indices to lookup into two hash tables in SRAM. The flow table stores 8,192 flow entries. Each flow entry holds the 155 bit flow tuple (to confirm a hit or a miss on the hash table), and a 152 bit field used to store parameters for an action when there is a lookup hit. The action fields include one bit to indicate a valid flow entry, three bits to identify a destination port (physical output port, port to CPU, or null port that drops the packet), 48 bit overwrite MAC DA, 48 bit overwrite MAC SA, a 20-bit packet counter, and a 32 bit byte counter. The 307-bit flow-entry is stored across two banks of SRAM 410 and 412.

Block 414 controls the SRAM, arbitrating access for two requesters: The flow table lookup (two accesses per packet, plus statistics counter updates), and the CPU 302 via a PCI bus. Every 16 system clock cycles, the block 414 can read two flow-tuples, update a statistics counter entry, and perform one CPU access to write or read 4 bytes of data. To prevent counters from overflowing, in the illustrated embodiment the byte counters need to be read every 30 seconds by the CPU 302, and the packet counters every 0.5 seconds. Alternatives can increase the size of the counter field to reduce the load on the CPU or use well-known counter-caching techniques.

Block 416 buffers packets while the header is processed in Blocks 402-408, 414. If there was a hit on the flow table, the packet is forwarded accordingly to the correct outgoing port, the CPU port, or could be actively dropped. If there was a miss on the flow table, the packet is forwarded to the CPU 302. Block 418 can also overwrite a packet header if the flow table so indicates. Packets are provided from block 418 to one of three queues 420, 422, 424. Queues 420 and 422 are connected to a mux 426 to provide packets to the Ethernet MAC FIFO 428. Two queues are used to allow prioritization of flows if desired, such as new flows to the controller 102. Queue 424 provides packets to the CPU 302 for operations not handled by the hardware. A fourth queue 430 receives packets from the CPU 302 and provides them to the mux 426, allowing CPU-generated packets to be directly transmitted.

Overall, the hardware is controlled by the CPU 302 via memory-mapped registers over the PCI bus. Packets are transferred using standard DMA.

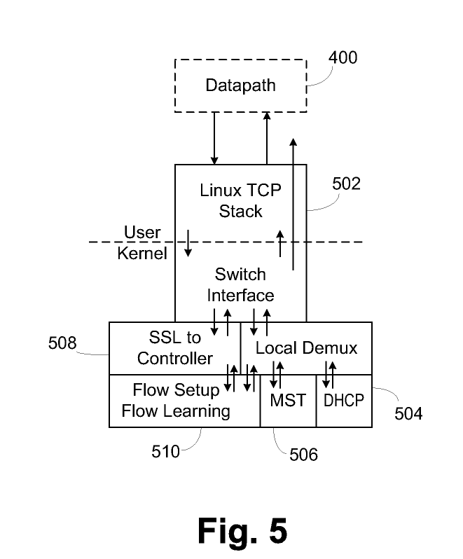

FIG. 5 contains a high-level view of the switch control path. The control path manages all communications with the controller such as forwarding packets that have failed local lookups, relaying flow setup, tear-down, and filtration requests.

The control path uses the local TCP stack 502 for communication to the controller using the datapath 400. By design, the datapath 400 also controls forwarding for the local protocol stack. This ensures that no local traffic leaks onto the network that was not explicitly authorized by the controller 102.

All per-packet functions that do not have per-packet time constraints are implemented within the control path. This ensures that the datapath will be simple, fast and amenable to hardware design and implementation. The implementation includes a DHCP client 504, a spanning tree protocol stack 506, a SSL stack 508 for authentication and encryption of all data to the controller, and support 510 for flow setup and flow-learning to support outbound-initiated only traffic.

The switch control and management software 314 has two responsibilities. First, it establishes and maintains a secure channel to the controller 102. On startup, all the switches 104 find a path to the controller 102 by building a modified spanning-tree, with the controller 102 as root. The control software 314 then creates an encrypted TCP connection to the controller 102. This connection is used to pass link-state information (which is aggregated to form the network topology) and all packets requiring permission checks to the controller 102. Second, the software 314 maintains a flow table for flow entries not processed in hardware, such as overflow entries due to collisions in the hardware hash table, and entries with wildcard fields. Wildcards are used for the small implementation-specific table. The software 314 also manages the addition, deletion, and timing-out of entries in the hardware.

If a packet does not match a flow entry in the hardware flow table, it is passed to software 314. The packet did not match the hardware flow table because: (i) It is the first packet of a flow and the controller 102 has not yet granted it access (ii) It is from a revoked flow or one that was not granted access (iii) It is part of a permitted flow but the entry collided with existing entries and must be managed in software or (iv) It matches a flow entry containing a wildcard field and is handled in software.

In the full software design of the switch two flow tables were maintained, one as a secondary hash table for implementation-specific entries and the second as an optimization to reduce traffic to the controller. For example, the second table can be set up symmetric entries for flows that are allowed to be outgoing only. Because you cannot predict the return source MAC address when proxy ARP is used, traffic to the controller is saved by maintaining entries with wildcards for the source MAC address and incoming port. The first flow table is a small associative memory to hold flow-entries that could not find an open slot in either of the two hash tables. In a dedicated hardware solution, this small associative memory would be placed in hardware. Alternatively, a hardware design could use a TCAM for the whole flow table in hardware.

The controller was implemented on a standard Linux PC (1.6 GHz Intel Celeron processor and 512 MB of DRAM). The controller is based on 45K lines of C++, with an additional 4K lines generated by the policy compiler, and 4.5K lines of python for the management interface.

Switches and hosts were registered using a web-interface to the controller and the registry was maintained in a standard database. For access points, the method of authentication was determined during registration. Users were registered using a standard directory service.

In the implemented system, users authenticated using the existing system, which used Kerberos and a registry of usernames and passwords. Users authenticate via a web interface. When they first connect to a browser they are redirected to a login web-page. In principle, any authentication scheme could be used, and most enterprises would have their own. Access points also, optionally, authenticate hosts based on their Ethernet address, which is registered with the controller.

The implemented controller logged bindings whenever they were added, removed or on checkpointing the current bind-state. Each entry in the log was timestamped.

The log was easily queried to determine the bind-state at any time in the past. The DNS server was enhanced to support queries of the form key.domain.type-time, where “type” can be “host”, “user”, “MAC”, or “port”. The optional time parameter allows historical queries, defaulting to the present time.

Routes were pre-computed using an all pairs shortest path algorithm. Topology recalculation on link failure was handled by dynamically updating the computation with the modified link-state updates. Even on large topologies, the cost of updating the routes on failure was minimal. For example, the average cost of an update on a 3,000 node topology was 10 ms.

The implementation was deployed in an existing 100 Mb/s Ethernet network. Included in the deployment were eleven wired and eight wireless switches according to the present invention. There were approximately 300 hosts on the network, with an average of 120 hosts active in a 5-minute window. A network policy was created to closely match, and in most cases exceed, the connectivity control already in place. The existing policy was determined by looking at the use of VLANs, end-host firewall configurations, NATs and router ACLs, omitting rules no longer relevant to the current state of the network.

Briefly, within the policy, non-servers (workstations, laptops, and phones) were protected from outbound connections from servers, while workstations could communicate uninhibited. Hosts that connected to a switch port registered an Ethernet address, but required no user authentication. Wireless nodes protected by WPA and a password did not require user authentication, but if the host MAC address was not registered they can only access a small number of services (HTTP, HTTPS, DNS, SMTP, IMAP, POP, and SSH). Open wireless access points required users to authenticate through the existing system. The VoIP phones were restricted from communicating with non-phones and were statically bound to a single access point to prevent mobility (for E911 location compliance). The policy file was 132 lines long.

By deploying this embodiment, measurements of performance were made to understand how the network can scale with more users, end-hosts and switches. In the deployed 300 host network, there were 30-40 new flow-requests per second with a peak of 750 flow-requests per second. Under load the controller flows were set up in less than 1.5 ms in the worst case, and the CPU showed negligible load for up to 11,000 flows per second, which is larger than the actual peak detected. This number would increase with design optimization.

With this in mind, it is worth asking to how many end-hosts this load corresponds. Two recent datasets were considered, one from an 8,000 host network and one from a 22,000 host network at a university. The number of maximum outstanding flows in the traces from the first network never exceeded 1,500 per second for 8,000 hosts. The university dataset had a maximum of under 9,000 new flow-requests per second for 22,000 hosts.

This indicates that a single controller could comfortably manage a network with over 20,000 hosts. Of course, in practice, the rule set would be larger and the number of physical entities greater; but on the other hand, the ease with which the controller handled this number of flows suggests there is room for improvement.

Next the size of the flow table in the switch was evaluated. Ideally, the switch can hold all of the currently active flows. In the deployed implementation it never exceeded 500. With a table of 8,192 entries and a two-function hash-table, there was never a collision.

In practice, the number of ongoing flows depends on where the switch is in the network. Switches closer to the edge will see a number of flows proportional to the number of hosts they connect to—and hence their fanout. The implemented switches had a fanout of four and saw no more than 500 flows. Therefore a switch with a fanout of, say, 64 would see at most a few thousand active flows. A switch at the center of a network will likely see more active flows, presumably all active flows. From these numbers it is concluded that a switch for a university-sized network should have a flow table capable of holding 8-16 k entries. If it is assumed that each entry is 64 B, it suggests the table requires about 1 MB; or as large as 4 MB if using a two-way hashing scheme. A typical commercial enterprise Ethernet switch today holds 1 million Ethernet addresses (6 MB, but larger if hashing is used), 1 million IP addresses (4 MB of TCAM), 1-2 million counters (8 MB of fast SRAM), and several thousand ACLs (more TCAM). Therefore the memory requirements of the present switch are quite modest in comparison to current Ethernet switches.

To further explore the scalability of the controller, its performance was tested with simulated inputs in software to identify overheads. The controller was configured with a policy file of 50 rules and 100 registered principles. Routes were pre-calculated and cached. Under these conditions, the system could handle 650,845 bind events per second and 16,972,600 permission checks per second. The complexity of the bind events and permission checks is dependent on the rules in use and in the worst case grows linearly with the number of rules.

Because the implemented controller used cold-standby failure recovery, a controller failure would lead to interruption of service for active flows and a delay while they were re-established. To understand how long it took to reinstall the flows, the completion time of 275 consecutive HTTP requests, retrieving 63 MBs in total was measured. While the requests were ongoing, the controller was crashed and restarted multiple times. There was clearly a penalty for each failure, corresponding to a roughly 10% increase in overall completion time. This could be largely eliminated, of course, in a network that uses warm-standby or fully-replicated controllers to more quickly recover from failure.

Link failures require that all outstanding flows re-contact the controller in order to re-establish the path. If the link is heavily used, the controller will receive a storm of requests, and its performance will degrade. A topology with redundant paths was implemented, and the latencies experienced by packets were measured. Failures were simulated by physically unplugging a link. In all cases, the path re-converged in under 40 ms; but a packet could be delayed by up to a second while the controller handled the flurry of requests.

The network policy allowed for multiple disjoint paths to be setup by the controller when the flow was created. This way, convergence could occur much faster during failure, particularly if the switches detected a failure and failed over to using the backup flow-entry.

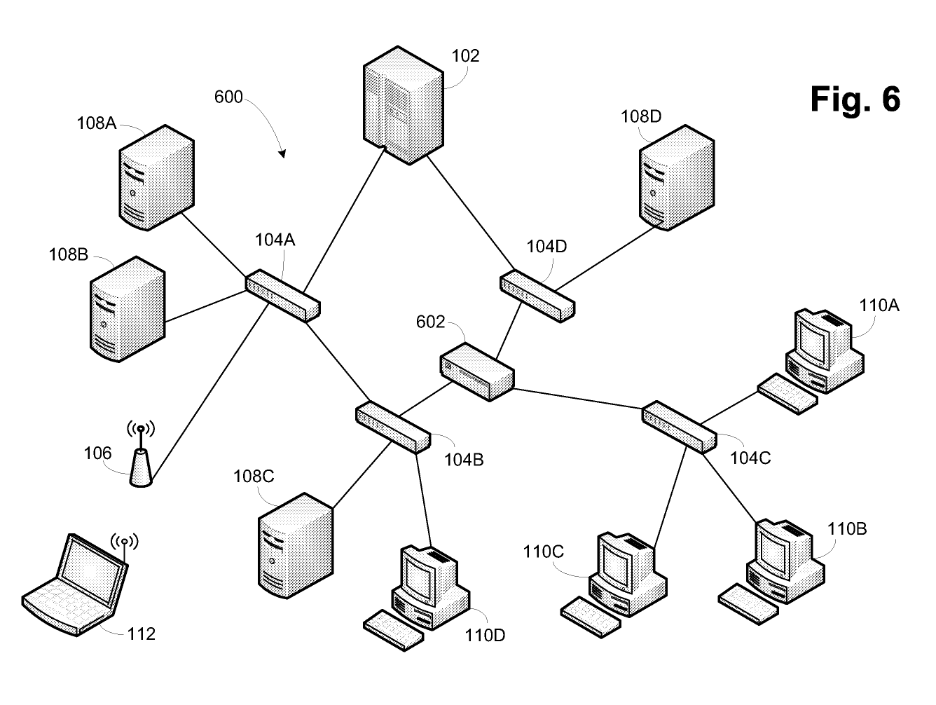

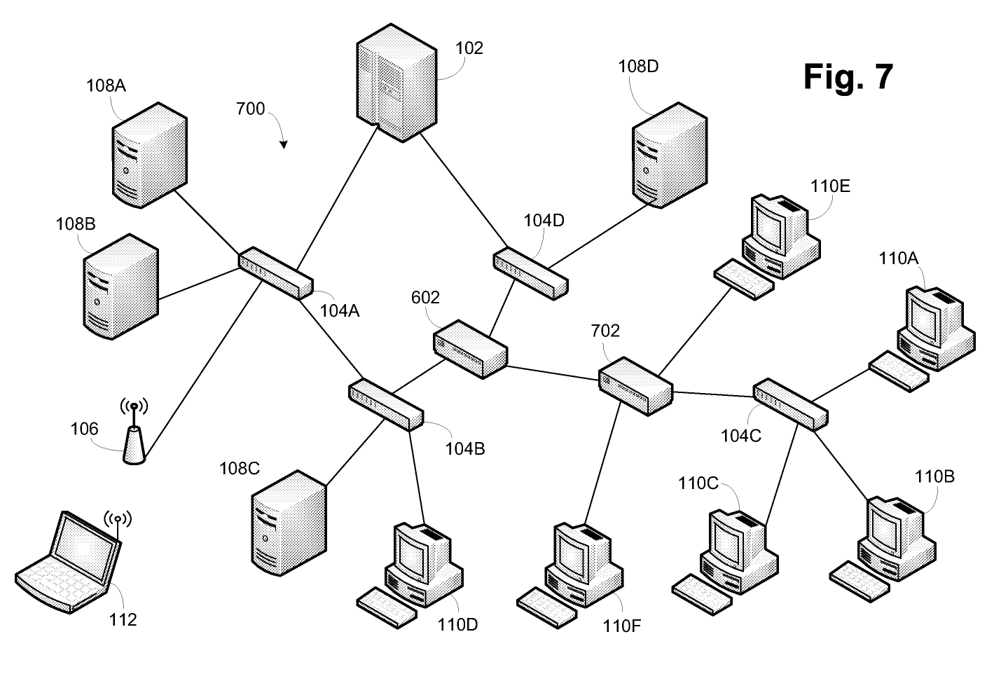

FIGS. 6 and 7 illustrate inclusion of prior art switches in a network according to the present invention. This illustrates that a network according to the present invention can readily be added to an existing network, thus allowing additional security to be added incrementally instead of requiring total replacement of the infrastructure.

In FIG. 6, a prior art switch 602 is added connecting to switches 104B, 104C and 104D, with switches 104B and 104D no longer being directly connected to switch 104C. FIG. 7 places a second prior art switch 702 between switch 602 and switch 104D and has new workstations 110E and 110F connected directly to it.

Operation of the mixed networks 600 and 700 differs from that of network 100 in the following manners. In the network 600, full network control can be maintained even though a prior art switch 602 is included in the network 600. Any flows to or from workstations 110A, 110B and 110C, other than those between those workstations, must pass through switch 602. Assuming a flow from workstation 110A, after passing through switch 602 the packet will either reach switch 104B or switch 104C. Both switches will know the incoming port which receives packets from switch 602. Thus a flow from workstation 110C to server 108D would have flow table entries in switches 104D and 104C. The entry in switch 104D would be as in network 100, with the TCP/UDP, IP and Ethernet headers and the physical receive port to which the workstation 110C is connected. The flow table would include an action entry of the physical port to which switch 602 is connected so that the flow is properly routed. The entry in switch 104C would include the TCP/UDP, IP and Ethernet headers and the physical receive port to which the switch 602 is connected. Thus if switch 104C receives a similarly addressed packet but at another port, it knows it should forward the packet to the controller 102. Therefore, because the controller 102 will learn the routing table of the switch 602 during the initial flow set ups, it will be able to properly set up flows in all of the switches 110 in the network to maintain full security.

The network 700 operates slightly differently due to the inter-connected nature of switches 602 and 702 and to the workstations 110E and 110F being connected to switch 702. Communications between workstations 110E and 110F can be secured only using prior art techniques in switch 702. Any other communications will be secure as they must pass through switches 104.

Thus it can be seen that a fully secure network can be developed if all of the switches forming the edge of the network are switches according to the present invention, even if all of the core switches are prior art switches. In that case the controller 102 will flood the network to find the various edge switches 104. As the switches 104 will not be configured, they will return the packet to the controller 102, thus indicating their presence and locations.

Appreciable security can also be developed in a mixed network which uses core switches according to the present invention and prior art switches at the edge. As in network 700, there would be limited security between hosts connected to the same edge switch but flows traversing the network would be secure.

A third mixed alternative is to connect all servers to switches according to the present invention, with any other switches of less concern. This arrangement would secure communications with the servers, often the most critical. One advantage of this alternative is that fewer switches might be required as there are usually far fewer servers than workstations. Overall security would improve as any prior art switches are replaced with switches according to the present invention.

Thus switches according to the present invention, and the controller, can be incorporated into existing networks in several ways, with the security level varying dependent on the deployment technique, but not requiring a complete infrastructure replacement.

This description describes a new approach to dealing with the security and management problems found in today's enterprise networks. Ethernet and IP networks are not well suited to address these demands. Their shortcomings are many fold. First, they do not provide a usable namespace because the name to address bindings and address to principle bindings are loose and insecure. Secondly, policy declaration is normally over low-level identifiers (e.g., IP addresses, VLANs, physical ports and MAC addresses) that don't have clear mappings to network principles and are topology dependant. Encoding topology in policy results in brittle networks whose semantics change with the movement of components. Finally, policy today is declared in many files over multiple components. This requires the human operator to perform the labor intensive and error prone process of manual consistency.

Networks according to the present invention address these issues by offering a new architecture for enterprise networks. First, the network control functions, including authentication, name bindings, and routing, are centralized. This allows the network to provide a strongly bound and authenticated namespace without the complex consistency management required in a distributed architecture. Further, centralization simplifies network-wide support for logging, auditing and diagnostics. Second, policy declaration is centralized and over high-level names. This both decouples the network topology and the network policy, and simplifies declaration. Finally, the policy is able to control the route a path takes. This allows the administrator to selectively require traffic to traverse middleboxes without having to engineer choke points into the physical network topology.

While the invention has been particularly shown and described with respect to preferred embodiments thereof, it will be understood by those skilled in the art that changes in form and details may be made therein without departing from the scope and spirit of the invention.

1. A method for operating a packet switching network, the network including a plurality of switches interconnected to allow packets received at a switch to be provided to each switch, at least one of the plurality of switches being a secure switch, the network further including a controller connected to at least one of the plurality of switches and able to receive packets from the secure switch, a plurality of hosts connected to selected of the plurality of switches, the secure switch including a flow table with entries indicating allowable flows between hosts and directions for forwarding allowable flows, the method comprising the steps of:
the secure switch developing a secure connection with the controller;
the controller authenticating a host connected to the secure switch;
the host initiating a flow to another host;
the secure switch interrogating a flow table upon receiving a flow from a host, determining if the flow is contained in the flow table, forwarding at least the first packet of the flow to the controller if the flow is not contained in the flow table and forwarding the packets as directed by the flow table if the flow is contained in the flow table; and
the controller receiving the at least first packet of a flow not contained in the flow table of the secure switch, determining that the flow is allowed, setting up a flow table entry in the secure switch upon determining that the flow is allowed and returning the packet to the secure switch for further flow table interrogation after setting up the flow table entry in the secure switch.

2. The method of claim 1 further comprising the steps of:
the controller receiving an authentication request from a user of the host; and
the controller authenticating the user and thereafter including user information in the determination if a flow is allowed.

3. The method of claim 1, wherein a plurality of secure switches are included in the network and each perform the steps of developing secure connections with the controller, interrogating a flow table; forwarding to the controller if not contained in the flow table and forwarding as directed if contained in the flow table, and
wherein the controller sets up flow table entries in each secure switch if the secure switch is in the flow path between the hosts of the flow.

4. The method of claim 1, further comprising the step of:
the secure switch creating a spanning tree rooted at the controller.

5. A packet switching network for connecting a plurality of hosts, the network comprising:
a plurality of switches for connection to the plurality of hosts, said plurality of switches interconnected to allow packets received at a switch to be provided to each switch, said plurality of switches including a secure switch which includes a flow table with entries indicating allowable flows between hosts and directions for forwarding allowable flows; and
a controller, said controller connected to said secure switch,
wherein said secure switch and said controller interact to developing a secure connection between themselves,
wherein said controller authenticates a host when connected to said secure switch,
wherein said secure switch interrogates said flow table upon receiving a flow from a host, determines if said flow is contained in said flow table, forwards at least the first packet of said flow to said controller if said flow is not contained in said flow table and forwards the packets as directed by said flow table if said flow is contained in said flow table; and
wherein said controller receives said at least first packet of said flow not contained in said flow table of said secure switch, determines that said flow is allowed, sets up a flow table entry in said secure switch upon determining that said flow is allowed and returns said at least first packet to said secure switch for further flow table interrogation after setting up said flow table entry in said secure switch.

6. The network of claim 5 wherein said controller authenticates a user of the host providing said flow to said secure switch; and
wherein after authenticating the user, said controller thereafter includes user information in the determination if a flow is allowed.

7. The network of claim 5, wherein said secure switch creates a spanning tree rooted at said controller.

8. The network of claim 5, wherein said plurality of switches include a plurality of secure switches, each including flow tables,
wherein each of said secure switches and said controller interact to develop secure connections,
wherein each of said secure switches interrogate their said flow table; forward at least the first packet of said flow to said controller if said flow is not contained in said flow table and forward the packets as directed by said flow table if said flow is contained in said flow table, and
wherein said controller sets up flow table entries in each of said secure switches if the secure switch is in the flow path between the hosts of said flow.

9. The network of claim 8, wherein said secure switches are all of said plurality of switches.

10. The network of claim 5, wherein at least one switch of said plurality of switches is not a secure switch, and
wherein said at least one switch which is not a secure switch is interconnected with the remainder of said plurality of switches so that at least some flows between the hosts pass through said at least one switch which is not a secure switch.

11. A controller for use in a packet switching network connecting a plurality of hosts, the network including a plurality of switches for connection to the plurality of hosts, the plurality of switches interconnected to allow packets received at a switch to be provided to each switch, the plurality of switches including a secure switch which includes a flow table with entries indicating allowable flows between hosts and directions for forwarding allowable flows, the controller comprising:
a network interface for interconnection to at least one of said plurality of switches;
a CPU coupled to said network interface; and
memory coupled to said CPU and storing data and software programs executed on said CPU, said software programs including:
an operating system;
a component to interact with the secure switch to develop a secure connection between said controller and the secure switch;
a component to authenticate a host when connected to the secure switch; and
a component to receive at least a first packet of a flow between two hosts not contained in the flow table of the secure switch, to determine that said flow is allowed, to set up a flow table entry in the flow table in the secure switch upon determining that said flow is allowed and to return said at least first packet to the secure switch after setting up said flow table entry in the secure switch.

12. The controller of claim 11, wherein said software programs further include:
a component to authenticate a user of the host providing said flow to the at least one switch, and
wherein after authenticating the user, said component which determines if a flow is allowed thereafter including user information in the determination if a flow is allowed.

13. The controller of claim 11, wherein at least two switches of the plurality of switches are secure switches and include flow tables,
wherein said component to interact with the at least one switch to develops a secure connection each of the secure switches,
wherein said component to authenticate a host authenticates hosts connected to each of the plurality of the secure switches,
wherein said component to receive at least a first packet, to determine that said flow is allowed, to set up a flow table entry in the flow table and to return said at least first packet does so for each of the plurality of the secure switches and further sets up flow table entries in each of the plurality of the secure switches if the secure switch is in the flow path between the hosts of the flow.

14. The controller of claim 11, wherein said software programs further include:
a component to maintain the topology of the network, said topology component cooperating with said component to set up flow table entries.

15. The controller of claim 11, wherein said software programs further include:
a component to maintain network policies, said policy component cooperating with said component determined if the flow is allowed.

16. The controller of claim 11, wherein said component to authenticate a host when connected to the secure switch further provides an IP address to the host.

17. A secure switch for use in a packet switching network for connecting a plurality of hosts, the network including a controller and a plurality of switches, the plurality of switches interconnected to allow packets received at a switch to be provided to each switch and to the controller, the secure switch comprising:
a network interface for interconnection to at least one of said plurality of switches and to which a host may be connected;
memory containing a flow table, said flow table including entries indicating allowable flows between hosts and directions for forwarding allowable flows;
logic coupled to said network interface to interact with the controller to develop a secure connection between the controller and the secure switch;
logic coupled to said network interface to receive a flow from a host and interrogate said flow table upon receiving said flow, determine if said flow is contained in said flow table, forward at least the first packet of said flow to the controller if said flow is not contained in said flow table and forward the packets as directed by said flow table if said flow is contained in said flow table;
logic coupled to said network interface to receive flow table entries from the controller and place them in said flow table; and
logic coupled to said network interface to receive a packet returned from the controller and provide it to the logic to interrogate said flow table.

18. The secure switch of claim 17, further comprising:
logic coupled to said network interface to create a spanning tree rooted at the controller.

19. The secure switch of claim 17, further comprising:
a CPU coupled to said network interface; and
memory coupled to said CPU and storing data and software programs executed on said CPU, said software programs including:
an operating system;
a component to handle control operations of the secure switch; and
a component to handle data operations of the secure switch,
wherein said component to handle control operations forms at least a portion of said logic to develop a secure connection between the controller and the secure switch, and
wherein one of said component to handle control operations and said component to handle data operations forms at least a portion of said logic coupled to said network interface to receive flow table entries from the controller and place them in said flow table.

20. The secure switch of claim 17, wherein directions for forwarding allowable flows in said flow table include forwarding the packet to an indicated port, altering a header in the packet and place the packet in a designated queue.

21. The secure switch of claim 17, wherein said flow table entries include packet header information and incoming port number to allow comparison with a received packet.
